(19) United States
(12) Patent Application Publication
(10) Pub. No.: US 2010/0133785 A1
(43) Pub. Date: Jun. 3, 2010

(54) HITCH BALL ASSEMBLY

(76) Inventor: Richard McCoy, Granger, IN (US)

Correspondence Address: MCDONALD HOPKINS LLC, 600 Superior Avenue, East, Suite 2100, CLEVELAND, OH, 44114-2653, US

(21) Appl. No.: 12/615,740

(22) Filed: Nov. 10, 2009

Related U.S. Application Data
(60) Provisional application No. 61/198,834, filed on Nov. 10, 2008.

(51) Int. Cl. B60D 1/46; B60D 1/06

(52) U.S. Cl. 280/490.1; 280/492

(57) ABSTRACT

A dual hitch ball assembly is described. The hitch ball assembly may couple a towing vehicle to a towed vehicle. The hitch ball assembly may include a hitch bar, a base member and at least one hitch ball. The hitch bar may be removably secured to a hitch receiver on the towing vehicle. The base member may be located on an end of the hitch bar. A first hitch ball may be located on a side of the base member and may be capable of being coupled with the towed vehicle. A second hitch ball may be located on an opposite side of the base member and may be capable of being coupled with the towed vehicle. The hitch balls may have different diameters. The hitch bar may also include at least one webbed area. The hitch bar and the hitch balls may be a one-piece integrally formed component.

### CROSS-REFERENCE TO RELATED APPLICATION

This application claims benefit from U.S. Provisional Patent Application No. 61/198,834, entitled “Hitch Ball Assembly,” filed on Nov. 10, 2008, which is hereby incorporated in its entirety by reference.

### FIELD OF INVENTION

The present invention relates generally to a towing assembly and, more particularly, to a dual hitch ball assembly.

### BACKGROUND

Many vehicles, such as trucks, are designed to transport freight, goods, merchandise, personal property, and other such cargo. Typically, a towed vehicle or trailer may be connected to a towing vehicle by way of a hitch assembly or coupling member. The hitch assembly may include a ball hitch or member secured to the towing vehicle and a ball socket or coupling mechanism secured on the towed vehicle or trailer.

For example, the ball socket may be mounted over the hitch ball thereby allowing the trailer to pivot behind the towing vehicle. Ball and socket-type towing mechanisms may be used on a wide variety of vehicles, such as automobiles, SUVs, trucks, tractors, and the like. The socket-to-hitch ball connection may allow for relative movement between the towing vehicle and the trailer as the towing vehicle makes turns, traverses uneven or rough terrain, and passes along inclining and declining roadways.

The socket structure of a coupler mechanism is typically affixed to the trailer or towed vehicle. Generally, the socket or coupler may be secured to a tongue or extension of the frame of the trailer. Often, the sockets of trailers may be of various sizes whereby hitch ball members of different sizes and diameters may be required for this purpose. As a result, it is not uncommon for different types of trailers to be equipped with sockets that may be adapted for use with hitch balls of different sizes and diameters. As the sockets are frequently permanently attached to the towed vehicle, the hitch ball of the towing vehicle must be removed and replaced with a hitch ball corresponding in size to the desired socket of the trailer. Removing the hitch ball and replacing the hitch ball with another sized hitch ball is inconvenient and time consuming for the user.

For example, such hitch balls may typically be provided with a threaded mounting shank that may be inserted through an aperture in a hitch bar located on the towing vehicle. The hitch ball may be secured to the hitch bar with a nut and locking washer. This is typically inconvenient for the user, as the user may be required to stoop or lay on the ground in order to secure or remove the hitch ball from the hitch bar. This may be particularly frustrating if the ground is wet or muddy. The user must then attach the hitch ball corresponding in size to the given socket in order to complete the hitch ball replacement.

As is known, hitch balls may be of various sizes and diameters. Typically, there have been several industry standard sizes (e.g., 1⅞ inch, 2 inch, 2¼ inch and 2 5/16 inch in diameter) that may be in frequent use. As a result, it is not uncommon for a single towing vehicle to be used to tow various trailers wherein those trailers may be equipped with socket or coupler assemblies that may be adapted for operative connection with the hitch balls of different diameters.

Current hitch assemblies may have deficiencies regarding the construction of the hitch ball and the hitch bar. Typically, the hitch ball may be secured to the hitch bar by inserting the shaft integrally formed with the hitch ball into an aperture located in the hitch bar and then securing the shaft with use of a fastener. Therefore, there is a need in the art for an improved dual hitch ball assembly that is easily interchangeable in order to be able to connect to different sized sockets. There is also a need for improved fabrication of the hitch bar to reduce costs as well as to improve the strength and durability of the hitch bar construction.

### SUMMARY

A dual hitch ball assembly is described. The dual hitch ball assembly may couple a towing vehicle to a towed vehicle. The hitch ball assembly may include a hitch bar, a base member and at least one hitch ball. The hitch bar may include a first end and a second end, wherein the first end may be capable of being removably secured to a hitch receiver on the towing vehicle. The base member may be located on the second end of the hitch bar. A first hitch ball may be located on a side of the base member, wherein the first hitch ball may be capable of being coupled with the towed vehicle. A second hitch ball may be located on an opposite side of the base member, wherein the second hitch ball may be capable of being coupled with the towed vehicle. The hitch balls may have different diameters. The hitch bar may also include at least one webbed area. The hitch bar and the hitch balls may be a one-piece integrally formed component.

### DESCRIPTION OF THE DRAWINGS

Objects and advantages together with the operation of the invention may be better understood by reference to the following detailed description taken in connection with the following illustrations, wherein:

FIG. 1 illustrates a perspective view of a dual hitch ball assembly.

FIG. 2 illustrates another perspective view of the dual hitch ball assembly.

FIG. 3 illustrates a first side view of the dual hitch ball assembly.

FIG. 4 illustrates a second side view of the dual hitch ball assembly.

FIG. 5 illustrates a top view of the dual hitch ball assembly.

FIG. 6 illustrates a bottom view of the dual hitch ball assembly.

FIG. 7 illustrates a front view of the dual hitch ball assembly.

FIG. 8 illustrates a rear view of the dual hitch ball assembly.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

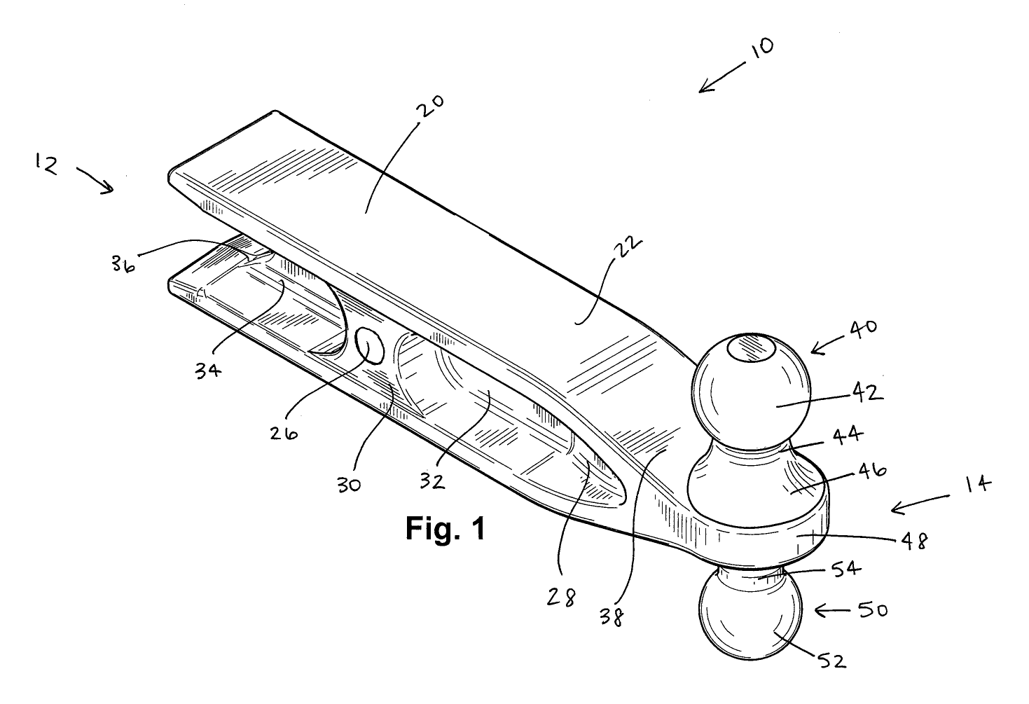

A dual hitch ball assembly 10 is shown in FIGS. 1-8. The dual hitch ball assembly 10 may be removeably secured to a hitch receiver (not shown). The hitch receiver may be located on a towing vehicle, such as an automobile, truck, SUV, or the like. The dual hitch ball assembly 10 may be easily interchangeable so that it may be connected to different sized sockets that may be located on a variety of towed vehicles.

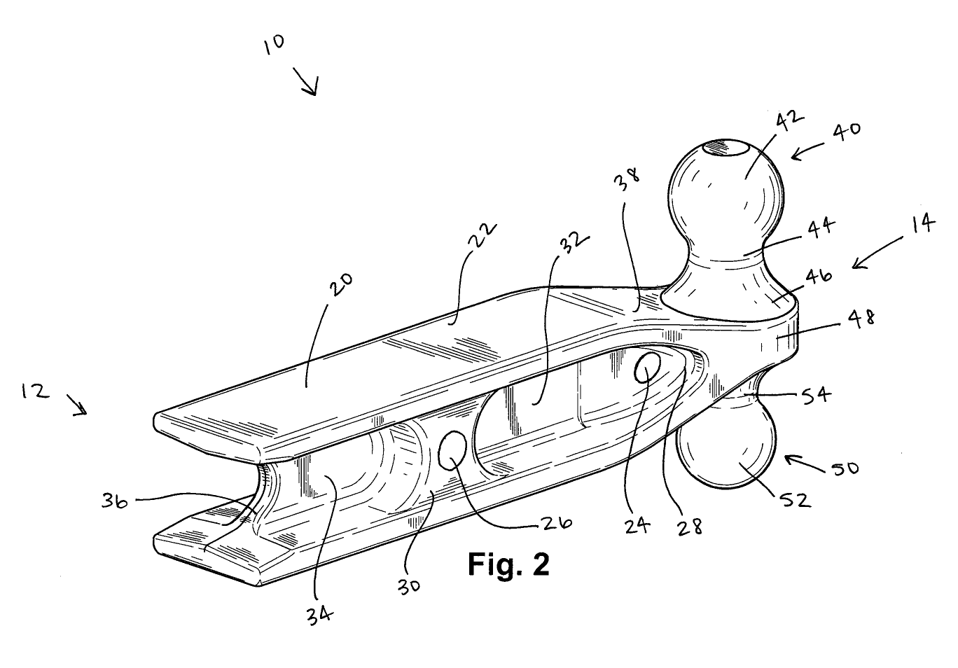

The dual hitch ball assembly 10 may include a hitch bar 20 and one or more hitch ball members 40, 50 (FIGS. 1-4). For example, the hitch ball assembly 10 may include two hitch ball members 40, 50. The hitch ball assembly 10 may also include a first end 12 and a second end 14. The hitch bar 20 may be generally located towards the first end 12 of the hitch ball assembly 10 and extend towards the second end 14. The hitch ball members 40, 50 may be generally located near the second end 14 (FIGS. 1 and 2).

The hitch bar 20 may be of any appropriate shape or size, such as a generally rectangular, tubular, cylindrical, or I-beam shape. The hitch bar 20 may be fabricated out of any appropriate material or process, such as being investment cast, cast, molded, forged, or otherwise formed as a single component. Fabricating the hitch bar 20 as a single integral component may reduce costs as well as to improve the strength and durability of the hitch bar 20 construction.

The hitch bar 20 may be connected to a vehicle. In one example, the hitch bar 20 may be connected to a hitch receiver mounted to a vehicle. The hitch receiver may be attached to the vehicle by any appropriate means, such as by being welded to the frame of the vehicle, secured under the bumper of the vehicle, or connected to the vehicle by other appropriate means. The hitch receiver may have an opening (not shown) that may be sized and shaped similar to that of the hitch bar 20, whereby the hitch receiver may be configured to receive the hitch bar 20. The hitch bar 20 may be shaped and sized so that it may be inserted into the hitch receiver.

For example, the hitch bar 20 may be of a shape and size that corresponds to the shape and size of the hitch receiver. The hitch bar 20 may be secured to the hitch receiver by any appropriate means, such as by fasteners or the like. The hitch bar 20 may be inserted into the hitch receiver lengthwise and extend outward from the hitch receiver for connection to the towed vehicle. In addition, the hitch bar 20 may be a weight distributing hitch bar. Utilizing a weight disturbing hitch bar may distribute part of the trailer's hitch weight from the towing vehicle's rear axle to the towing vehicle's front axle and to the trailer's axles.

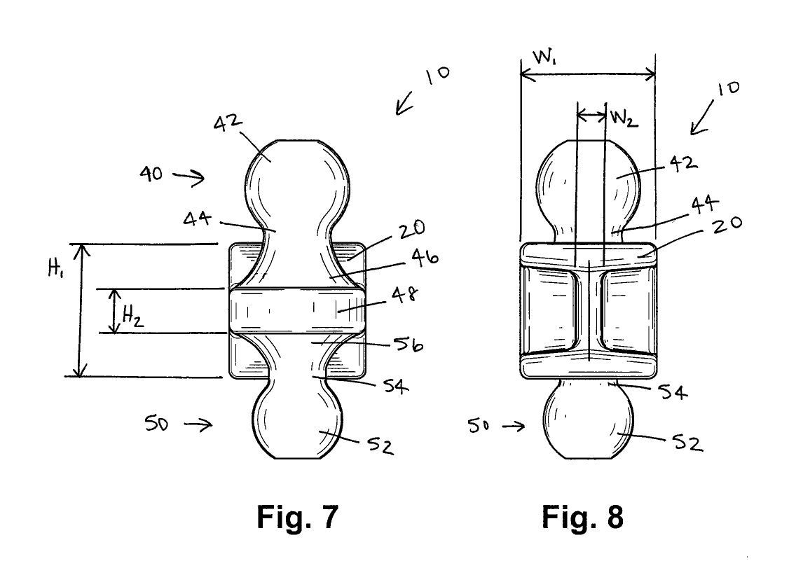

The hitch bar 20 may be of a general I-beam construction. The hitch bar 20 may include an upper surface 22 and a lower surface 22. The upper and lower surfaces 22 may be generally planar (FIGS. 1 and 2). For example, the hitch bar 20 may have a height H₁ located at a first end 12 of the hitch bar 20 and a height H₂ at an opposite second end 14 of the hitch bar 20 (FIGS. 4 and 7). The height H₁ may substantially correspond to the height of the hitch receiver. The height H₁ may greater than the height H₂.

The hitch ball assembly 10 may also include a notched portion 36, a narrow portion 38, and a ball member base portion 48 (FIGS. 1-4). The notched portion 36 may be of any appropriate shape or size, such as a generally semi-circular, semi-ovular or semi-rectangular shape. The notched portion 36 may be located at any appropriate position, such as adjacent the first end 12 of the hitch bar 20. The notched portion 36 may also be located and extend between the upper and lower surfaces 22 of the hitch bar 20. By removing some of the material at the first end 12, the notched portion 36 may allow the first end 12 of the hitch bar 20 to flex thereby reducing stresses in the hitch receiver.

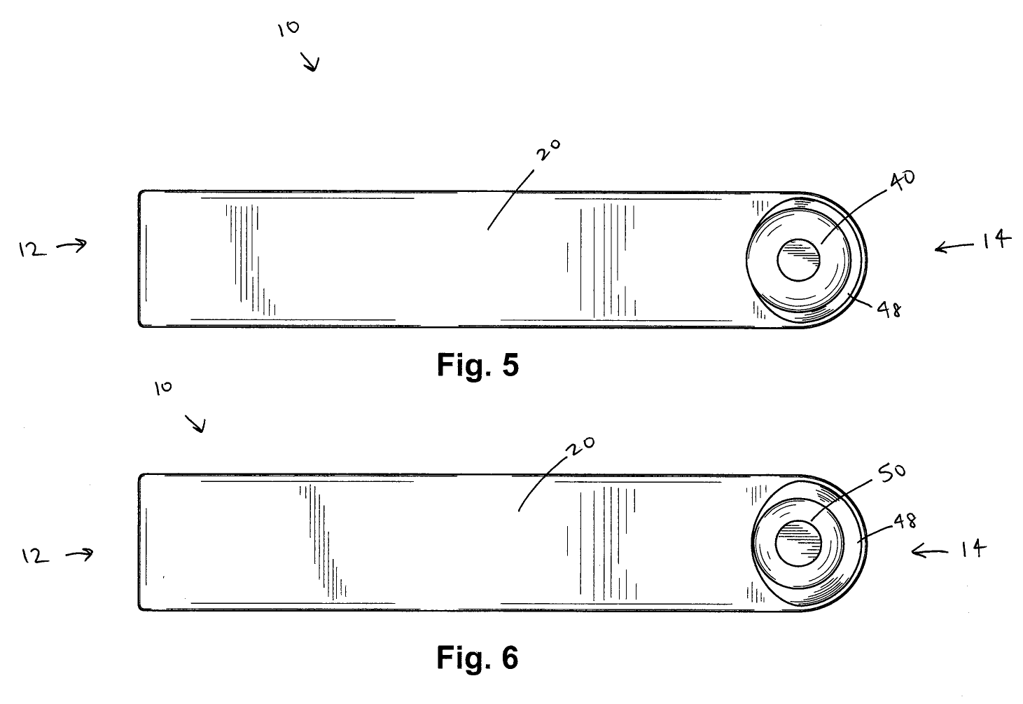

The narrow portion 38 may be of any appropriate shape or size, such as a generally ovular or triangular shape. The narrow portion 38 may be located at any appropriate position, such as adjacent the second end 14. The narrow portion 38 may be located wherein the upper and lower surfaces 22 being to converge towards one another (FIGS. 1-4). The ball member base portion 48 may be of any appropriate shape or size, such as a generally circular, ovular or rectangular shape. The base portion 48 may be located at any appropriate position, such as near the second end 14 of the hitch ball assembly 10 (FIGS. 5 and 6). As the two surfaces 22, 24 continue to converge past the narrow portion 38, they begin to become one as the base portion 48. The base portion 48 may provide a base for the hitch ball members 40, 50 to be mounted to (FIGS. 1-4 and 7).

The hitch bar 20 may include one or more attachment apertures. For example, the hitch bar 20 may include two attachment apertures 24, 26. The apertures 24, 26 may be of any appropriate shape or size, such as a generally circular, ovular or rectangular shape. The apertures 24, 26 may be of a similar shape and size or the apertures 24, 26 may be of differing shapes and sizes. The apertures 24, 26 may be located at any appropriate position on the hitch bar 20, such as along the general center of the hitch bar 20. The first aperture 24 may be located near the second end 14 and adjacent the hitch ball members 40, 50. The second aperture 26 may be located towards the first end 12.

The attachment apertures 24, 26 may secure the hitch bar 20 to the hitch receiver. The hitch receiver may include apertures (not shown). The apertures of the hitch receiver may be configured to align with the attachment apertures 24, 26 in the hitch bar 20 when the hitch bar 20 is inserted into the hitch receiver. When the apertures 24, 26 of the hitch bar 20 are aligned with the apertures of the hitch receiver, the hitch bar 20 may be secured in place by inserting a fastener, such as a pin (not shown), through the aligned apertures. The apertures 24, 26 may also be used for attaching any appropriate type of accessory to the hitch bar 20, such as a pintle accessory (not shown). For example, use of a pintle hook may allow a user to tow a trailer that has a lunette ring.

The hitch bar 20 may include at least one webbed area. For example, the hitch bar 20 may include two webbed areas 32, 34. The webbed areas 32, 34 may be of any appropriate shape or size, such as generally ovular, rectangular or oblong shapes. The webbed areas 32, 34 may be of a generally similar or differing shapes and sizes. For example, the webbed areas 32, 34 may be indentations or recesses located in the hitch bar 20 (FIGS. 1 and 2).

The webbed areas 32, 34 may reduce the amount of material used to manufacture the hitch bar 20. In addition, when the hitch bar 20 is molded or cast, the webbed areas 32, 34 may assist in removing the hitch bar 20 from the mold or casting. The hitch bar 20 may have a width W₁ along the general length of the hitch bar 20 and a W₂ along the webbed areas 32, 34 (FIG. 8). The width W₂ at the webbed areas 32, 34 of the hitch bar 20 may be less than the maximum width W₁ of the hitch bar 20. For example, the width W₂ of the hitch bar 20 at the webbed areas 32, 34 may be the minimum width of the hitch bar 20.

The webbed areas 32, 34 may be located at any appropriate position on the hitch bar 20. For example, the first webbed area 32 may be located towards the second end 14. The first webbed area 32 may also be located between the first aperture 24 and the second aperture 26 (FIGS. 2-4). The second webbed area 34 may be located towards the first end 12. For example, the second webbed area 34 may be located between the second aperture 26 and the notched portion 36 (FIGS. 1-4).

The hitch bar 20 may also include one or more protruding or thicker sections. For example, the hitch bar 20 may include two thicker sections 28, 30. The thicker sections 28, 30 may be of any appropriate shape or size, such as a generally rectangular or triangular shape. The thicker sections 28, 30 may be of a generally similar shape and size or may be of differing shapes and sizes. For example, the thicker sections 28, 30 may be protrusions or bulges located in the hitch bar 20 (FIGS. 1 and 2). The thicker sections 28, 30 may be of a width between the width W₁ of the hitch bar 20 and the width W₂ of the webbed portions 32, 34.

The first thicker section 28 may be located towards the second end 14 and adjacent the narrow portion 38. The first thicker section 28 may also be located between the base member 48 and the webbed portion 32. The second thicker section 30 may be located towards the first end 12 and between the webbed portions 32, 34. In addition, the apertures 24, 26 may be located within the thicker sections 28, 30 whereby the thicker sections 28, 30 may provide additional material and strength to the apertures 24, 26.

The ball members 40, 50 may be of any appropriate shape or size, such as a generally spherical shape. The ball members 40, 50 may be of any appropriate or conventional size. For example, the ball members 40, 50 may be shaped for insertion into a corresponding socket of the trailer to be towed. The ball members 40, 50 may be of different sizes and diameters, such as different standard sized hitch balls (FIGS. 5 and 6). In a non-limiting example, the ball members 40, 50 may have a diameter of 1⅞ inches, 2 inches, or 2 5/16 inches.

The ball members 40, 50 may be integrally formed with the hitch bar 20 or may be separate, removable components that may be secured to the hitch bar 20 by any appropriate means, such as welding, fasteners, or the like. For example, the hitch bar 20 and the ball members 40, 50 may all be of a one-piece, integrally formed component. While the hitch ball assembly 10 is shown and described as having two hitch ball members 40, 50, it is to be understood that there may be any appropriate number of hitch ball members 40, 50 of any appropriate shape or size and the hitch ball assembly 10 should not be limited to that shown or described herein.

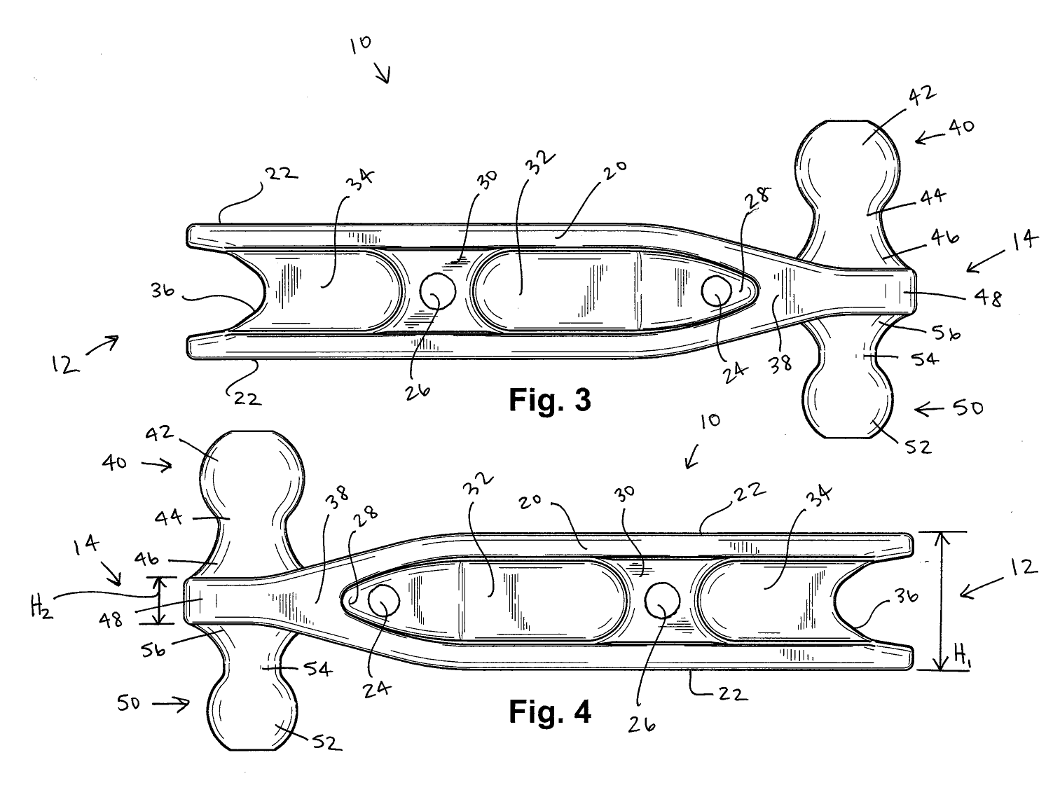

The first hitch ball member 40 may include a ball portion 42, a neck 44 and a base 46 (FIGS. 1-4 and 7). The second hitch ball member 50 may include a ball portion 52, a neck 54 and a base 56 (FIGS. 3, 4 and 7). The ball members 40, 50 may generally be coaxially aligned, such as being aligned along a substantially vertical axis. The base portions 46, 56 of each ball member 40, 50 may be integrally formed with the base member 48.

The ball members 40, 50 may be located at any appropriate position on the hitch ball assembly 10. For example, one ball member 40 may be positioned on one side of the hitch bar 20 and the other ball member 50 may be positioned on the opposite side of the hitch bar 20. A user may insert the hitch bar 20 into the hitch receiver such that one of the ball members 40 may extend upwardly, whereby that ball member 40 may be readily connectable to the towed vehicle. If the user requires use of the other ball member 50, the user may remove the hitch bar 20 from the hitch receiver and reinsert the hitch bar 20 so that the other ball member 50 may extend upwardly for connection to the towed vehicle.

The invention has been described above and, obviously, modifications and alterations will occur to others upon a reading and understanding of this specification. The claims as follows are intended to include all modifications and alterations insofar as they come within the scope of the claims or the equivalent thereof.

1. A hitch ball assembly comprising:
a hitch bar comprising:
a first end and a second end;
said first end has a first height, includes a notched portion extending between an upper surface and a lower surface of said hitch bar, wherein said first end is capable of being secured to a hitch receiver on a towing vehicle;
at least one webbed area between said upper and lower surfaces of said hitch bar;
a base member located on said second end of said hitch bar having a second height;
a narrow portion on said hitch bar extending to said base member;
wherein said first height is greater than said second height; and
at least one hitch ball integrally formed on said base member, wherein said hitch ball is capable of being coupled with a towed vehicle.

2. The hitch ball assembly of claim 1, wherein said hitch bar includes two webbed areas.

3. The hitch ball assembly of claim 1, wherein said hitch bar includes at least one aperture capable of being aligned and secured to a hitch receiver aperture.

4. The hitch ball assembly of claim 1, wherein said hitch bar includes at least one accessory aperture capable of attachment to a pintle accessory.

5. The hitch ball assembly of claim 1, wherein said hitch ball assembly includes two hitch balls.

6. The hitch ball assembly of claim 5, wherein said hitch balls have a diameter of 1⅞ inches and 2 5/16 inches respectively.

7. The hitch ball assembly of claim 2, wherein said hitch bar includes at least one protruding section located between said webbed areas.

8. The hitch ball assembly of claim 7, wherein said hitch bar aperture is located through said protruding section.

9. The hitch ball assembly of claim 5, wherein said hitch bar and said hitch balls are a one-piece cast.

10. A dual hitch ball assembly for coupling a towing vehicle to a towed vehicle, said hitch ball assembly comprising:
a hitch bar comprising:
a first end and a second end;
said first end has a first height, includes a notched portion extending between an upper surface and a lower surface of said hitch bar, wherein said first end is capable of being removably secured to a hitch receiver on a towing vehicle;
a base member located on said second end of said hitch bar having a second height;
a narrow portion on said hitch bar extending to said base member;
wherein said first height is greater than said second height;
a first hitch ball located on a side of said base member, wherein said first hitch ball is capable of being coupled with the towed vehicle; and
a second hitch ball located on an opposite side of said base member, wherein said second hitch ball is capable of being coupled with the towed vehicle.

11. The hitch ball assembly of claim 10, wherein said hitch bar includes at least one webbed area between said upper and lower surfaces of said hitch bar.

12. The hitch ball assembly of claim 10, wherein said hitch bar assembly is a one-piece integrally formed component.

13. The hitch ball assembly of claim 12, wherein said hitch bar assembly is cast.

14. The hitch ball assembly of claim 10, wherein said hitch bar includes at least one aperture capable of being aligned and secured to a hitch receiver aperture.

15. The hitch ball assembly of claim 10, wherein said hitch bar includes at least one accessory aperture capable of attachment to a pintle accessory.

16. The hitch ball assembly of claim 1, wherein said first hitch ball has a diameter that is larger than a diameter of said second hitch ball.

17. The hitch ball assembly of claim 16, wherein said first hitch ball and said second hitch ball are coaxially aligned on said base member.
